(19) United States
(12) Patent Application Publication
(10) Pub. No.: US 2014/0116378 A1
(43) Pub. Date: May 1, 2014

(54) INTAKE AND INJECTION DEVICE, SYSTEM, AND INTERNAL COMBUSTION ENGINE

(71) Applicants: Andreas Posselt, Muehlacker (DE); Marko Lorenz, Grossbottwar (DE); Andreas Gutscher, Markgroeningen (DE)

(72) Inventors: Andreas Posselt, Muehlacker (DE); Marko Lorenz, Grossbottwar (DE); Andreas Gutscher, Markgroeningen (DE)

(21) Appl. No.: 14/111,833

(22) PCT Filed: Mar. 12, 2012
(86) PCT No.: PCT/EP2012/054254

§ 371 Date: Dec. 18, 2013

(30) Foreign Application Priority Data
Apr. 14, 2011 (DE) 10 2011 007 367.1

(51) Int. Cl. F02M 57/00

(52) U.S. Cl. CPC F02M 57/00
USPC 123/337

(57) ABSTRACT

An intake and injection device for an internal combustion engine, in particular of a motorcycle, is provided, having a fuel injector system, which is situated in an intake manifold leading to a combustion chamber of the internal combustion engine. The fuel injector system is designed for injecting fuel both in the direction of a first inlet opening and in the direction of a second inlet opening of the combustion chamber. The intake and injection device also has a throttle valve situated in the intake manifold, which is pivotable around a rotational axis. The intake and injection device is designed in such a way that the rotational axis extends essentially in parallel to an intermediate plane, which extends centrally through the intake manifold between the first and second inlet openings.

### FIELD OF THE INVENTION

The present invention is directed to an intake and injection device for an internal combustion engine.

### BACKGROUND INFORMATION

Devices for injecting and igniting fuel for internal combustion engines are generally known in principle. For example, an internal combustion engine having at least one combustion chamber is known from the publication German Published Patent Application No. 10 2008 044 244, the combustion chamber having two fuel inlet openings, which are each closable by an intake valve. The internal combustion engine also has a fuel injection device, which, assigned to the at least one combustion chamber, has a first fuel injector and a separate second fuel injector for the metered injection of fuel into at least one intake manifold of the combustion chamber. The fuel injectors inject the atomized fuel in the form of spray jets in the direction of the intake valves. Furthermore, a throttle valve is situated in the intake manifold, which is pivotable around a rotational axis depending on the requested performance and thus permits the suctioning of a corresponding quantity of air into the combustion chamber as a function of the requested performance.

### SUMMARY

The intake and injection device according to the present invention for an internal combustion engine, the system according to the present invention for the intake, injection, and ignition of fuel of an internal combustion engine, and the internal combustion engine according to the present invention has the advantage over the related art that the internal combustion engine is operable with improved engine smoothness and reduced exhaust gas emissions. The throttle valve of the intake and injection device according to the present invention is situated rotated by approximately 90° in relation to the throttle valve known from the related art, so that the rotational axis extends essentially in parallel to the intermediate plane. This has the advantage that the air stream suctioned in in the direction of the first and second inlet openings is allocated somewhat asymmetrically by a partially open throttle valve and is swirled more strongly. During the injection of the fuel through the injection device, better mixing of fuel and air therefore occurs, so that a more homogeneous air-fuel mixture is produced. In particular, the air stream is swirled in such a way that different air flows and preferably also different quantities of air are suctioned in in the direction of the first and second inlet openings. Increased mixing of the air-fuel mixture in the combustion chamber is achieved in this way. Such increased mixing improves the ignition and combustion of the air-fuel mixture in the combustion chamber, whereby the engine smoothness of the internal combustion engine is improved and flaws in the combustion process, misfiring, or incomplete combustion of the fuel mixture are prevented. In this way, a reduction of the crude exhaust gases is also achieved. In addition, the compatibility for exhaust gas remaining in the combustion chamber from the prior combustion is increased. Due to the crude exhaust gas reduction, the catalytic converter may advantageously be dimensioned smaller and some of the noble metals required for the catalytic converter may be saved. The improved combustion and the improved engine smoothness achieved in this way additionally allow a lower idle speed, which in turn reduces the greenhouse gas emissions. Furthermore, due to the optimized mixing of the air-fuel mixture in the combustion chamber, it is possible to drive in the part-load range with an elevated residual gas fraction, whereby the fuel consumption is reduced. The internal combustion engine preferably includes more than one cylinder, each of the cylinders including one combustion chamber, with each having two intake valves and one throttle valve pivotable around a rotational axis, the rotational axis extending essentially in parallel to an intermediate plane in each cylinder, the intermediate plane extending between the first and second inlet openings centrally through the intake manifold. The intake and injection device includes in particular a cylinder head of the internal combustion engine, the internal combustion engine being the internal combustion engine of a motorcycle in particular. The fuel injector system preferably injects fuel within the scope of an upstream injection or an intake-synchronized injection, the upstream injection particularly preferably being combined with optimized spray targeting. Reduced exhaust gas emissions in the cold start phase may be achieved in this way. In the case of intake-synchronized injection, increased filling and a reduced tendency to knock of the internal combustion engine in normal operation at full load are achieved (cooling of the fresh air charge in the combustion chamber due to lesser intake manifold and cylinder wall wetting).

According to one preferred specific embodiment, it is provided that the throttle valve is designed in such a way that a first quantity of air suctioned in through the partially open throttle valve in the direction of the first inlet opening is not equal to a second quantity of air suctioned in through the partially open throttle valve in the direction of the second inlet opening and/or the throttle valve is designed in such a way that the throttle valve is situated in the intake manifold in such a way that upon opening of the throttle valve, a first vane of the throttle valve moves toward a first inlet opening and a second vane of the throttle valve moves away from the second inlet opening. A throttle valve fundamentally has two vanes separated from one another by the rotational axis, during pivoting of the throttle valve in the intake manifold, for example, in the event of the request for a larger quantity of air (“to accelerate”), one of the vanes moves in the direction of the combustion chamber and the other vane moves in the opposite direction. Due to this geometry, the vane which moves in the direction of the combustion chamber permits a greater air flow rate than the other vane. In the case of the arrangement of the throttle valve known from the related art, the greater air flow rate is distributed to both inlet openings, since the vane moving in the direction of the combustion chamber moves equally in the direction of the first and second inlet openings. In the case of the intake and injection device according to the present invention, the greater air flow rate at one of the vanes advantageously only favors one of the two inlet openings, while the other inlet opening is supplied with less air. In this way, different quantities of air-fuel mixture reach the combustion chamber through the first and second inlet openings, whereby the improved mixing of the air-fuel mixture in the combustion chamber, which is linked to the above-mentioned advantages, is achieved.

According to one preferred specific embodiment, it is provided that the fuel injector system has a first fuel injector for injecting fuel both in the direction of the first inlet opening and in the direction of the second inlet opening. A comparatively synchronous injection through the first and second inlet openings is advantageously achieved by the use of only one single fuel injector. The first fuel injector preferably has two separate injection cones, by which two separate injection cones are produced. One of the injection cones is directed toward the first inlet opening, while the other injection cone is directed toward the second inlet opening.

According to one preferred specific embodiment, it is provided that the fuel injector system has a first fuel injector for injecting fuel in the direction of the first inlet opening and a second fuel injector for injecting fuel in the direction of the second inlet opening. The combustion is promoted by the use of two separate fuel injectors, since each fuel injector only has to inject a reduced flow rate of fuel and at the same time allows more degrees of freedom in the formation of the spray cone, whereby optimized spray targeting and lower spray density are achieved, i.e., the characteristic droplet size, in particular the Sauter mean diameter of the atomized fuel, is advantageously reduced. The use of two separate fuel injectors also has the advantage that each individual fuel injector can be designed for a lower flow rate of fuel than if only one single fuel injector had to inject the entire quantity of fuel, and the smallest quantity which may still be injected by the fuel injectors with high precision is thus advantageously reduced. In the event of a lower flow rate, the switching times for each of the intake valves, in order to inject the same quantity of fuel, are additionally lengthened. In this way, the precision of the injection procedure is substantially increased and the risk that the first fuel injector will operate in the nonlinear range is avoided. The intake and injection device therefore also allows very precise injection of the required quantity of fuel in the case of dynamic operating states, which are induced by large load changes. The engine performance in the event of load changes, for example, from idle speed to full load or from a low load to a high load, is increased or nonstationary mixture deviations are reduced. By setting a nearly optimum air-fuel mixture, the mixing and combustion are additionally promoted, whereby improved engine smoothness and reduced CO₂ emissions may be achieved in the event of load changes.

According to one preferred specific embodiment, it is provided that the first fuel injector and the second fuel injector are activatable separately from one another. In this way, individual activation of the fuel injectors is possible to optimize the combustion process in the combustion chamber. For example, the post-injection procedure explained hereafter may be implemented: Calculating the quantity of fuel required in the future with the aid of load prediction methods and controlling the fuel injector accordingly to inject the calculated quantity of fuel into the intake manifold is known from the related art. In internal combustion engines having intake manifold injection, the fuel is normally injected prior to the intake stroke with respect to time. If the throttle valve is suddenly strongly opened after the injection with respect to time, for example, because the driver requests an increased torque, more air flows into the combustion chamber than was originally assumed for the calculation of the required quantity of fuel. Since the injection procedure is already completed at this point in time, the quantity of the fuel may no longer be adapted to the greater quantity of air, so that the air-fuel mixture in the combustion chamber is made leaner and therefore the risk exists of a performance drop, and possibly even misfires. This problem is solved in that post-injection of further fuel is carried out as long as the intake valve is still open. By using two separate fuel injectors, which are activatable separately from one another, comparatively precise post-injection of a small quantity of further fuel is possible, since due to the use of the two separate fuel injectors for each valve, the smallest quantity which may still be injected by the fuel injectors at high precision is reduced, and in the event of a lower flow rate, the switching times for each one of the fuel injectors to inject the same quantity of fuel are lengthened, so that a longer switching pulse is required for the post-injection of the further fuel. In this way, the precision of the post-injection procedure is substantially increased and the risk that one of the fuel injectors will operate during the post-injection in the nonlinear range is avoided. Alternatively, it is conceivable that the first and second fuel injectors are activated in parallel.

According to one preferred specific embodiment, it is provided that the first fuel injector and the second fuel injector are dimensioned differently in such a way that different quantities of fuel are injected by the first fuel injector and the second fuel injector. In this way, the smallest delivery quantity may be reduced further and the increase of the precision during the fuel injection may be increased. Furthermore, different quantities of fuel are injectable using the first and second fuel injectors, in particular in spite of parallel activation, whereby additionally increased swirling of the air-fuel mixture results in the combustion chamber, whereby the mixing is improved further. Furthermore, the quantities of fuel may be adapted individually to the differently distributed air stream, and homogeneity of the mixture flowing into the combustion chamber may be improved.

According to one preferred specific embodiment, it is provided that the intake manifold has an intermediate wall in an end section facing toward the combustion chamber, the intermediate wall dividing the intake manifold into a first channel section leading to the first inlet opening and a second channel section leading to the second inlet opening, the intermediate plane and the intermediate wall being situated essentially in parallel to one another. The spray cone of each fuel injector may thus be adapted advantageously in a simple way to the particular channel section, and to the particular inlet opening, so that, on the one hand, wetting of the outer walls of the intake manifold and, on the other hand, wetting of a partition wall between the first and second inlet openings, may be effectively suppressed.

A further object of the present invention is a system for the intake, injection, and ignition of fuel of an internal combustion engine, in particular of a motorcycle, having an intake and injection device according to the present invention and at least one combustion chamber, whose wall has a first inlet opening closable by a first intake valve and a second inlet opening closable by a second intake valve, the device having a first spark plug assigned to the first intake valve and a second spark plug assigned to the second intake valve. In this way, a reduction of the exhaust gas emissions during operation of the internal combustion and in particular in the starting and warm-up phase of the internal combustion engine is achieved. The use of the two separate spark plugs has the result that the air-fuel mixture arriving in the combustion chamber through the first inlet opening and the second inlet opening is ignited at two different ignition points, whereby more rapid and stable combustion of the fuel mixture in the combustion chamber is achieved. In this way, flaws in the combustion process, misfires, or incomplete combustion of the fuel mixture are avoided and a reduction of the crude exhaust gases is achieved. In particular in the starting and warm-up phase, i.e., in the case of a cold catalytic converter which is not yet (completely) converting, this results in a reduction of the exhaust gas emissions at the catalytic converter outlet. The ignition and combustion of the fuel mixture in the combustion chamber which is improved in this way therefore results in higher combustion stability and furthermore, via retarded ignition timing, in an elevated temperature in the combustion chamber at the point in time of the opening of the outlet valve (or the outlet valves) and therefore also in hotter crude exhaust gases. The catalytic converter is thus warmed up more rapidly in the starting and warm-up phase and reaches the light-off temperature, from which the catalytic converter operates efficiently, more rapidly. This also results in a reduction of the exhaust gas emissions.

According to one preferred specific embodiment, it is provided that the first spark plug is situated in the combustion chamber in such a way that a fuel injected by the first fuel injector through the first intake valve into the combustion chamber is essentially ignited by the first spark plug, and the second spark plug is situated in the combustion chamber in such a way that a fuel injected by the second fuel injector through the second intake valve into the combustion chamber is essentially ignited by the second spark plug. Advantageously, the fuel mixture arriving in the combustion chamber through the first fuel injector is directly ignited with the aid of the first spark plug and the fuel mixture arriving through the second fuel injector in the combustion chamber is directly ignited with the aid of the second spark plug, so that a uniform flame front which travels continuously from the cylinder head in the direction of the piston is achieved. In this way, reliable ignition and stable and uniform combustion of the combustion chamber are ensured. The combustion chamber is preferably essentially divided into two halves, the first fuel injector, the first intake valve, and the first spark plug being provided for the combustion in one half and the second fuel injector, the second intake valve, and the second spark plug being provided for the combustion in the other half. The combustion is advantageously started at two points of the combustion chamber in this way, whereby the combustion behavior may be optimized in particular in large-volume combustion chambers.

A further object of the present invention is an internal combustion engine, in particular for a motorcycle, having a system according to the present invention for the intake, injection, and ignition of fuel.

Exemplary embodiments of the present invention are shown in the drawings and are explained in greater detail in the following description.

### BRIEF DESCRIPTION OF THE DRAWINGS

FIG. 1 shows a schematic view of an intake and injection device according to a first specific embodiment of the present invention.

FIG. 2 shows a schematic view of an intake and injection device according to a second specific embodiment of the present invention.

FIG. 3 shows a schematic view of an intake and injection device according to a third specific embodiment of the present invention.

FIG. 4 shows a schematic view of an intake and injection device according to a fourth specific embodiment of the present invention.

FIG. 5 shows a schematic view of a system for the intake, injection, and ignition according to a fifth specific embodiment of the present invention.

### DETAILED DESCRIPTION

Identical parts are always provided with identical reference numerals in the various figures and are therefore also generally only cited or mentioned once in each case.

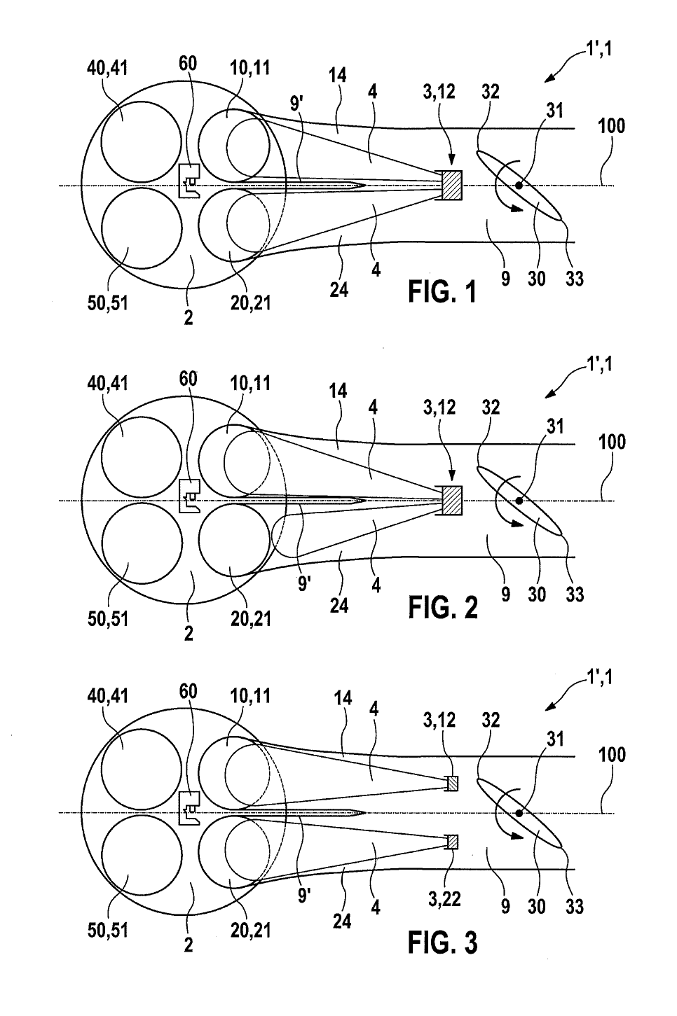

FIG. 1 shows a schematic view of an intake and injection device 1′ for an internal combustion engine 1 according to a first specific embodiment of the present invention. Internal combustion engine 1, which in the present example has only one cylinder, includes a combustion chamber 2, in which a piston 2′ moves. The wall of combustion chamber 2 has a first and a second inlet opening 10, 20, through each of which an air-fuel mixture is suctioned into combustion chamber 2, and a first and a second outlet opening 40, 50, through which the crude exhaust gases of the combusted air-fuel mixture are expelled from combustion chamber 2 into first and second outlet channels. Internal combustion engine 1 has a first intake valve 11, which is provided for closing first inlet opening 10 and is situated between a first channel section 14 of an intake manifold 9 and combustion chamber 2. Furthermore, internal combustion engine 1 has a second intake valve 21, which is provided for closing second inlet opening 20 and is situated between a second channel section 21 of intake manifold 9 and combustion chamber 2. Intake manifold 9 is subdivided at an end section, which faces toward combustion chamber 2, by an intermediate wall 9′ into first and second channel sections 14, 24. Fresh air is suctioned in through intake manifold 9 in the direction of combustion chamber 2. A fuel injector system 3, which only includes one first fuel injector 12, is situated in intake manifold 9. First fuel injector 12 injects fuel 4 in the form of two spray cones both in the direction of first inlet opening 10 and in the direction of second inlet opening 20, whereby a flammable air-fuel mixture forms in combustion chamber 2. A throttle valve 30 is situated in intake manifold 9 to regulate the quantity of air suctioned in. Throttle valve 30 is designed in such a way that it is pivotable around a rotational axis 31, which is perpendicular to the plane of the drawing, to regulate the quantity of air suctioned in. Rotational axis 31 is aligned parallel to an intermediate plane 100. Intermediate plane 100 extends centrally between the first and second inlet openings through intake manifold 9. Intermediate plane 100 and intermediate wall 9′ are also designed to be parallel to one another. Throttle valve 30 is made of a first and a second vane 32, 33, which are separated from one another by the rotational axis 31. In the case of a closed throttle valve 9, first vane 32 is situated on a side of intake manifold 9 corresponding to first channel section 14, while second vane 33 is situated on a side of intake manifold 9 corresponding to second channel section 24. The special orientation of rotational axis 31 has the result that upon opening of throttle valve 30, first vane 32 is moved toward first inlet opening 10 and second vane 33 is moved away from second inlet opening 20. A first quantity of air which is suctioned in in the area of first vane 32 through partially open throttle valve 30 in the direction of first inlet opening 10 is greater for flow-related technical reasons than a second quantity of air which is suctioned in in the area of second vane 33 through partially open throttle valve 30 in the direction of the second inlet opening, since suctioned-in air which flows centrally to throttle valve 30 is deflected in the direction of first vane 32. The air-fuel mixture arrives in combustion chamber 2 with significant swirling due to this asymmetry, whereby particularly good mixing of the air-fuel mixture is achieved in combustion chamber 2. A spark plug 60, which generates a defined spark in combustion chamber 2 for the initial ignition of the injected air-fuel mixture, is situated in the interior of combustion chamber 2. Intake manifold 9 is preferably formed by a pipe component, which is connected to a connecting piece of a cylinder head, the cylinder head being fastened on an engine block having the cylinder in order to close the cylinder. First fuel injector 12 is preferably fastened on the pipe component and is situated in particular on an upper wall section (which faces away from combustion chamber 2) of intake manifold 9. It is conceivable that fuel 4 is injected once with the aid of first fuel injector 12 per combustion cycle in each case. It is conceivable that in this case intake-synchronous injection takes place, i.e., a part of fuel 4 is transported to a wall of the cylinder opposite to inlet openings 10, 20. This fuel film vaporizes on the cylinder wall and therefore results in cooling of the combustion chamber temperature, whereby the tendency to knock of internal combustion engine 1 is reduced. Alternatively, upstream injection takes place, in order, in particular during a cold start, to prevent the formation of a fuel film on the wall of the cylinder opposite to inlet openings 10, 20, and therefore to achieve a reduction of the crude exhaust gases. In addition to the upstream injection, in combination with optimum spray targeting, the hydrocarbon emissions during the cold start may be decreased further. The injected fuel jet is aligned for this purpose in the direction of the channel base of first and second channel sections 14, 24, so that the suctioned in air-fuel mixture is displaced in the direction of the combustion chamber center and therefore wetting of the wall of the cylinder opposite to inlet openings 10, 20 is prevented. Wetting of the channel base and therefore a wall film formation in intake manifold 9 (or in first and second channel sections 14, 24) is achieved at the same time.

FIG. 2 shows a schematic view of an intake and injection device 1′ according to a second specific embodiment of the present invention, the second specific embodiment essentially being identical to the first specific embodiment illustrated in FIG. 1, injection system 3 of intake and injection device 1′ being designed according to the second specific embodiment in such a way that different quantities of fuel are injected in the direction of first inlet opening 10 and in the direction of second inlet opening 20. It is conceivable that injection system 3 is designed for a different fuel flow rate of the two jet cones. The mixing of the air-fuel mixture in combustion chamber 2 is further promoted by the asymmetry of the fuel injection.

FIG. 3 shows a schematic view of an intake and injection device 1′ according to a third specific embodiment of the present invention, the third specific embodiment essentially being identical to the first specific embodiment illustrated in FIG. 1, injection system 3 of intake and injection device 1′ according to the third specific embodiment having a first fuel injector 12 for injecting fuel 4 essentially exclusively in the direction of first inlet opening 10 and a separate second fuel injector 22 for injecting fuel 4 essentially exclusively in the direction of second inlet opening 20. The use of two separate fuel injectors 12, 22 has the advantage that the spray density of the spray cone is decreased, since each fuel injector 12, 22 only has to inject a reduced, in particular half, of the flow rate quantity of fuel 4, so that the characteristic droplet size, in particular the Sauter mean diameter, of atomized fuel 4 is advantageously reduced. A reduced Sauter mean diameter causes better combustion of the fuel mixture in combustion chamber 2 and therefore an elevated temperature in combustion chamber 2, whereby in particular the cold start properties of internal combustion engine 1 may be improved.

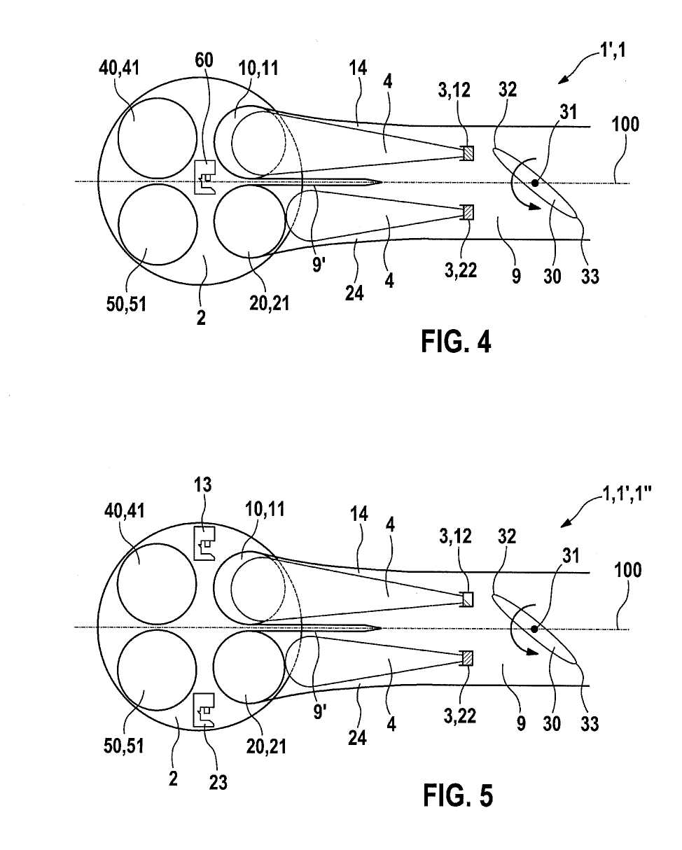

FIG. 4 shows a schematic view of an intake and injection device 1′ according to a fourth specific embodiment of the present invention, the fourth specific embodiment essentially being identical to the third specific embodiment illustrated in FIG. 3, first and second fuel injectors 12, 22 being dimensioned differently from one another in such a way that different quantities of fuel 4 are injected through first and second fuel injectors 12, 22. First and second fuel injectors 12, 22 are preferably also individually activatable, so that fuel 4 may be injected at different points in time. In this way, asymmetrical fuel injection may be implemented, by which the mixing of the air-fuel mixture in combustion chamber 2 is promoted further. Furthermore, it is conceivable that the individual activation of first and second fuel injectors 12, 22 is combined with a camshaft adjustment, so that advantageously the effect of a fresh air purge (scavenging) may be increased in the low-speed range at high load.

FIG. 5 shows a schematic view of a system 1″ for the intake, injection, and ignition of fuel 4 of an internal combustion engine 1 according to a fifth specific embodiment of the present invention, system 1″ having an intake and injection device 1′ for an internal combustion engine 1 according to the fourth specific embodiment of the present invention illustrated in

FIG. 4, and system 1″ also having a first spark plug 13 assigned to first intake valve 11 and a second spark plug 23 assigned to second intake valve 21. First spark plug 13 is situated in combustion chamber 2 adjacent to first inlet opening 10, while second spark plug 23 is situated in combustion chamber 2 adjacent to second inlet opening 20. A fuel 4 injected by first fuel injector 12 through first intake valve 11 into combustion chamber 2 is therefore essentially ignited by first spark plug 13, while a fuel 4 injected by second fuel injector 22 through second intake valve 21 into combustion chamber 2 is essentially ignited by second spark plug 23. First and second spark plugs 13, 23 are preferably activatable separately from one another. Furthermore, it is conceivable that first and second fuel injectors 12, 22 are activatable separately from one another. Particularly preferably, in this way, the procedure of injection of fuel 4 with the aid of first fuel injector 12 and ignition of this injected fuel 4 with the aid of first spark plug 13, on the one hand, and the procedure of injection of fuel 4 with the aid of second fuel injector 22 and ignition of this injected fuel with the aid of second spark plug 23, on the other hand, are activatable in parallel, individually, or as a combination of both. Furthermore, operation-dependent activation, for example, as a function of the throttle valve setting and/or the instantaneous temperature of internal combustion engine 1, is made possible.

1-10. (canceled)

11. An intake and injection device for an internal combustion engine, comprising:
a fuel injector system situated in an intake manifold leading to a combustion chamber of the internal combustion engine, wherein the fuel injector system injects a fuel both in a direction of a first inlet opening of the combustion chamber; and in a direction of a second inlet opening of the combustion chamber; and
a throttle valve pivotable around a rotational axis and situated in the intake manifold, wherein the rotational axis extends in parallel to an intermediate plane that extends centrally through the intake manifold between the first and second inlet openings.

12. The intake and injection device as recited in claim 11, wherein the internal combustion engine is of a motorcycle.

13. The intake and injection device as recited in claim 11, wherein at least one of:
the throttle valve is arranged in such a way that a first quantity of air that is suctioned in through the throttle valve, when partially open, in a direction of the first inlet opening, is not equal to a second quantity of air that is suctioned in through the partially open throttle valve in a direction of the second inlet opening, and
the throttle valve is situated in the intake manifold in such a way that upon opening of the throttle valve, a first vane of the throttle valve moves toward the first inlet opening and a second vane of the throttle valve moves away from the second inlet opening.

14. The intake and injection device as recited in claim 11, wherein the fuel injector system includes a first fuel injector for injecting the fuel both in the direction of the first inlet opening and in the direction of the second inlet opening.

15. The intake and injection device as recited in claim 11, wherein the fuel injector system includes a first fuel injector for injecting the fuel in the direction of the first inlet opening and a second fuel injector for injecting the fuel in the direction of the second inlet opening.

16. The intake and injection device as recited in claim 15, wherein the first and the second fuel injectors are activatable separately from one another.

17. The intake and injection device as recited in one of claim 15, wherein the first and the second fuel injectors are dimensioned differently in such a way that different quantities of the fuel are injected by the first and the second fuel injectors.

18. The intake and injection device as recited in claim 11, wherein the intake manifold has, in an end section facing toward the combustion chamber, an intermediate wall that subdivides the intake manifold into a first channel section leading to the first inlet opening and a second channel section leading to the second inlet opening, the intermediate plane and the intermediate wall being situated essentially in parallel to one another.

19. A system for the intake, injection, and ignition of a fuel of an internal combustion engine, having an intake and injection device for an internal combustion engine and at least one combustion chamber of the internal combustion engine, wherein the intake and the injection device includes a fuel injector system situated in an intake manifold leading to the at least one combustion chamber of the internal combustion engine, wherein the fuel injector system injects a fuel both in a direction of a first inlet opening of the combustion chamber and in a direction of a second inlet opening of the combustion chamber, and a throttle valve pivotable around a rotational axis and situated in the intake manifold, wherein the rotational axis extends in parallel to an intermediate plane that extends centrally through the intake manifold between the first and second inlet openings, wherein the first inlet opening is closable by a first intake valve and the second inlet opening is closable by a second intake valve, wherein the intake and injection device has a first spark plug assigned to the first intake valve and a second spark plug assigned to the second intake valve.

20. The system as recited in claim 19, wherein the internal combustion engine is of a motorcycle.

21. The system as recited in claim 19, wherein:
the first spark plug is situated in the at least one combustion chamber in such a way that the fuel injected by the first fuel injector through the first intake valve into the at least one combustion chamber is ignited by the first spark plug, and
the second spark plug is situated in the at least one combustion chamber in such a way that the fuel injected by the second fuel injector through the second intake valve into the combustion chamber is ignited by the second spark plug.

22. An internal combustion engine, comprising:
a system for the intake, injection, and ignition of a fuel of an internal combustion engine having an intake and injection device for an internal combustion engine and at least one combustion chamber of the internal combustion engine, wherein the intake and injection device includes a fuel injector system situated in an intake manifold leading to the at least one combustion chamber of the internal combustion engine, wherein the fuel injector system injects a fuel both in a direction of a first inlet opening of the combustion chamber and in a direction of a second inlet opening of the combustion chamber, and a throttle valve pivotable around a rotational axis and situated in the intake manifold, wherein the rotational axis extends in parallel to an intermediate plane that extends centrally through the intake manifold between the first and second inlet openings, wherein the first inlet opening is closable by a first intake valve and the second inlet opening is closable by a second intake valve, wherein the intake and injection device has a first spark plug assigned to the first intake valve and a second spark plug assigned to the second intake valve.

23. The internal combustion engine as recited in claim 22, wherein the internal combustion engine is for a motorcycle.
